(19) United States
(12) Patent Application Publication
(10) Pub. No.: US 2026/0038132 A1
(43) Pub. Date: Feb. 5, 2026

(54) IMAGE PROCESSING APPARATUS, IMAGE PROCESSING METHOD, AND COMPUTER-READABLE STORAGE MEDIUM

(71) Applicant: CANON KABUSHIKI KAISHA, Tokyo (JP)

(72) Inventor: HIDEYASU TASHIRO, Kanagawa (JP)

(21) Appl. No.: 19/280,293

(22) Filed: Jul. 25, 2025

(30) Foreign Application Priority Data
Aug. 2, 2024 (JP) 2024-128185

(51) Int. Cl. G06T 7/33; G06T 3/00

(52) U.S. Cl. CPC G06T 7/337; G06T 3/00

(57) ABSTRACT

An image processing apparatus that inspects a print product includes: an obtainment unit configured to obtain a print position misalignment amount between a reference image, which is a reference of an inspection, and an inspection image, which is a target of the inspection; a determination unit configured to determine an alignment region in the inspection image based on the print position misalignment amount, the alignment region being for alignment between the inspection image and the reference image and including a pattern included in the inspection image; and an alignment unit configured to perform alignment between the inspection image and the reference image based on the alignment region.

### CROSS-REFERENCE TO PRIORITY APPLICATION

This application claims the benefit of Japanese Patent Application No. 2024-128185, filed on Aug. 2, 2024, which is hereby incorporated by reference herein in its entirety.

### BACKGROUND

### Field of the Technology

The present disclosure relates to an inspection of a print product.

### Description of the Related Art

Conventionally, an inspection to determine whether there is a printing defect in an inspection image has been performed by comparing a reference image with the inspection image. However, since the inspection image is generated by scanning while conveying a print product, in some cases, a print position misalignment occurs in the inspection image compared with the reference image due to a conveyance position misalignment of the print product. To deal with this, Japanese Patent Laid-Open No. 2023-175441 (hereinafter, referred to as PTL 1) proposes a system that inspects the inspection image after registering the inspection image to the reference image. The inspection image includes a region of a sheet including a pattern and a region outside the sheet. The reference image includes a region of a sheet including a reference pattern and a region outside the sheet. In the system of PTL 1, the alignment is performed while including the region outside the sheet of each of the inspection image and the reference image.

### SUMMARY

An image processing apparatus according to an aspect of the present disclosure includes: an obtainment unit configured to obtain a print position misalignment amount between a reference image, which is a reference of an inspection of a print product, and an inspection image, which is a target of the inspection; a determination unit configured to determine a alignment region in the inspection image based on the print position misalignment amount, the alignment region being for alignment between the inspection image and the reference image and including a pattern included in the inspection image; and an alignment unit configured to perform alignment between the inspection image and the reference image based on the alignment region.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a configuration diagram of an entire printing system;

FIG. 2 is a block diagram illustrating a functional configuration of an image processing apparatus in FIG. 1;

FIG. 3 is a flowchart describing image processing executed by the image processing apparatus in FIG. 1;

FIG. 4A is a diagram illustrating the reference image 401, and FIG. 4B is a diagram illustrating the inspection image 405;

FIG. 5 is a flowchart describing print position misalignment amount obtainment processing in S303 in FIG. 3;

FIG. 6 is a flowchart describing alignment region determination processing in S304 in FIG. 3;

FIG. 7 is a flowchart describing alignment processing in S305 in FIG. 3;

FIG. 8A is a diagram illustrating the alignment region 404 including the pattern 403 of the reference image 401, and FIG. 8B is a diagram illustrating an alignment region 801 including the pattern 407 of the inspection image 405;

FIG. 9A is a diagram illustrating an example of the positions of the four corners of the sheet of the reference image 401, FIG. 9B is a diagram illustrating an example of a feature point of the pattern 403 of the reference image 401, FIG. 9C is a diagram illustrating an example of a feature point of the pattern 407 of the inspection image 405, and FIG. 9D is a diagram illustrating an example of the inspection image 915 generated by performing the alignment of a pixel position of the feature point of the pattern 407 of the inspection image 405 to a pixel position of the feature point of the pattern 403 of the reference image 401;

FIG. 10A is a diagram illustrating an example of the alignment region 404 of the reference image 401 used in the processing in S304 in FIG. 3, and FIG. 10B is a diagram illustrating an example of the alignment region 801 of the inspection image 405 used in the processing in S304 in FIG. 3;

FIG. 11A is a diagram illustrating an example of the multiple control points arranged on the alignment region 801, FIG. 11B is a diagram illustrating an example of an image region D_{l,m} in the vicinity of a control point P_{l,m} out of the multiple control points in FIG. 11A, and FIG. 11C is a diagram illustrating an example of a control point coordinate space that is coordinate-converted by using a control point 1101 that is an update target as the origin;

FIG. 12A is a diagram illustrating an example in which a crop mark 1204 is additionally set on the reference image 1201, and FIG. 12B is a diagram illustrating an example in which a crop mark 1209 is additionally set on the inspection image 1206;

FIG. 13 is a flowchart describing the alignment region determination processing in the second embodiment;

FIG. 14 is a flowchart describing exclusion processing in S1301 in FIG. 13;

FIG. 15A is a diagram illustrating a region 1403 that is a part of an alignment region 1401 of the inspection image 1206 and that overlaps an excluded region 1402 outside the sheet, and FIG. 15B is a diagram illustrating a region 1404 excluded from an alignment region 1205 of the reference image 1201;

FIG. 16A is a diagram illustrating an example in which additional printing is performed on the reference image 1501, and FIG. 16B is a diagram illustrating an example in which additional printing is performed on the inspection image 1506;

FIG. 17 is a flowchart describing the alignment region determination processing in the third embodiment;

FIG. 18A is a diagram illustrating an example in which a region 1703 that is a part of an alignment region 1701 of the inspection image 1506 and that overlaps a pre-print region 1702 is excluded, and FIG. 18B is a diagram illustrating an example in which a region 1704 that is a part of an alignment region 1505 of the reference image 1501 and that is obtained by moving parallel the region 1703 excluded from the inspection image 1506 is excluded;

FIG. 19 is a diagram illustrating another example of the exclusion region in the third embodiment;

FIG. 20 is a flowchart describing the image processing executed by the image processing apparatus in FIG. 1 in a fourth embodiment;

FIG. 21A is a diagram illustrating an example of a pre-print region 2102 and an emphasized inspection region 2104 set on a reference image 2101, FIG. 21B is a diagram illustrating an example of the pre-print region 2102 and an alignment region 2106 set on an inspection image 2105, and FIG. 21C is a diagram illustrating an example in which a part of the emphasized inspection region 2104 included in the reference image 2101 is excluded;

FIG. 22A is a diagram illustrating an example of a notification about unavailability of highly accurate inspection, and FIG. 22B is a diagram illustrating an example of a notification about changing to simple inspection; and

FIG. 23A is a diagram illustrating a conventional example in which the alignment also including the region outside the sheet is performed by the free shape alignment (FFD: Free-Form Deformations), which is known as the non-rigid alignment, and FIG. 23B is a flowchart describing a conventional example in which a pattern in a periphery of a paper end is distorted by the alignment to resolve a print position misalignment.

### DESCRIPTION OF THE EMBODIMENTS

Preferred embodiments of the present invention are described below in detail with reference to the appended drawings. Note that, the following embodiments are not intended to limit the matters of the present disclosure, and not all the combinations of the characteristics described in the following embodiments are necessarily required for the means for solving the problems of the present disclosure. Note that, the same reference numerals are provided to the same constituents.

### Overview

A colorant such as an ink and a toner is attached to an intended portion of a print product outputted from a printing apparatus. However, in some cases, with the above-described colorant being attached to an unintended portion of the print product, contamination occurs on the print product. Alternatively, in some cases, even in a case where the above-described colorant is attached to the intended portion of the print product, if the attachment of the above-described colorant is insufficient, the color is fainter than the actual color, and a color loss occurs on the print product. The contamination and the color loss as described above are one of printing defects and thus cause quality degradation of the print product. Therefore, conventionally, the quality of the print product has been ensured by inspecting whether there is the printing defect. However, since the inspection to visually determine whether there is the printing defect requires a lot of time and cost, there is a system that automatically inspects whether there is the printing defect. For example, the above-described system inspects whether there is the printing defect by performing alignment between a reference image and an inspection image and then calculating whether there is the printing defect based on a difference between the reference image and the inspection image. In this case, the reference image is registered in advance as an inspection reference of the print product. On the other hand, the inspection image is generated by scanning the conveyed print product. In some cases, local deformation occurs on the inspection image due to warping and the like of the print product during the conveyance and the scanning. In order to deal with the above-described local deformation, alignment processing to absorb the local deformation is required. However, first of all, in creating the print product by printing the inspection image on the sheet, a print position misalignment may occur because of random misalignment of a print position on the sheet along with a conveyance position misalignment of the sheet. Additionally, in some cases, the sheet is conveyed while the sheet end portion is misaligned more than expected in accordance with the conveyance position misalignment during printing, and thus a position of a sheet end portion on the reference image and a position of a sheet end portion on the inspection image are misaligned. As a result, the alignment between the reference image and the inspection image is performed in a state in which the positions of the sheet end portion on the reference image and the sheet end portion on the inspection image are different. For this reason, the sheet end portion on the inspection image is deformed such that the position of the sheet end portion on the inspection image matches the position of the sheet end portion on the reference image. The deformation of the sheet end portion on the inspection image is propagated also to a pattern in a periphery of the sheet, and thus the pattern in the periphery of the sheet is distorted. That is, in some cases, a part of the inspection image after alignment is locally distorted, and the alignment accuracy is decreased. To deal with this, a technique to reduce an effect of a relative position misalignment of the inspection image to the sheet even in a case where the print position misalignment occurs on the inspection image has been proposed. For example, as for the alignment processing, a technique to switch non-linear alignment processing to linear alignment processing by affine transformation and the like in a fixed region of an image end portion has been proposed. However, since the alignment processing is switched in the fixed region of the image end portion, in a case where a print position misalignment amount of the inspection image is greater than the fixed region, the alignment may be performed between the inspection image including a region outside the sheet and the reference image not including the region outside the sheet. In this case, a part of the image end portion is locally distorted, and thus the alignment accuracy is decreased. Therefore, in the present disclosure, based on the print position misalignment amount between the reference image and the inspection image, a alignment region including a pattern included in the inspection image, which is for the alignment between the inspection image and the reference image, is determined in the inspection image. Additionally, based on the alignment region, the alignment between the inspection image and the reference image is performed. According to the above-described processing, it is possible to reduce an effect of the print position misalignment due to the relative position misalignment between the sheet end portion and the inspection image. Therefore, it is possible to improve the alignment accuracy during the inspection of the print product. Details of the present disclosure are described below.

### First Embodiment

In a first embodiment, according to the print position misalignment amount between the reference image as a reference of the inspection and the inspection image as a target of the inspection, the alignment region in which the alignment between the inspection image and the reference image is performed is determined. An example in which the effect of the print position misalignment is reduced by the above-described processing even in a case of the inspection image having a great print position misalignment is described.

### Printing System

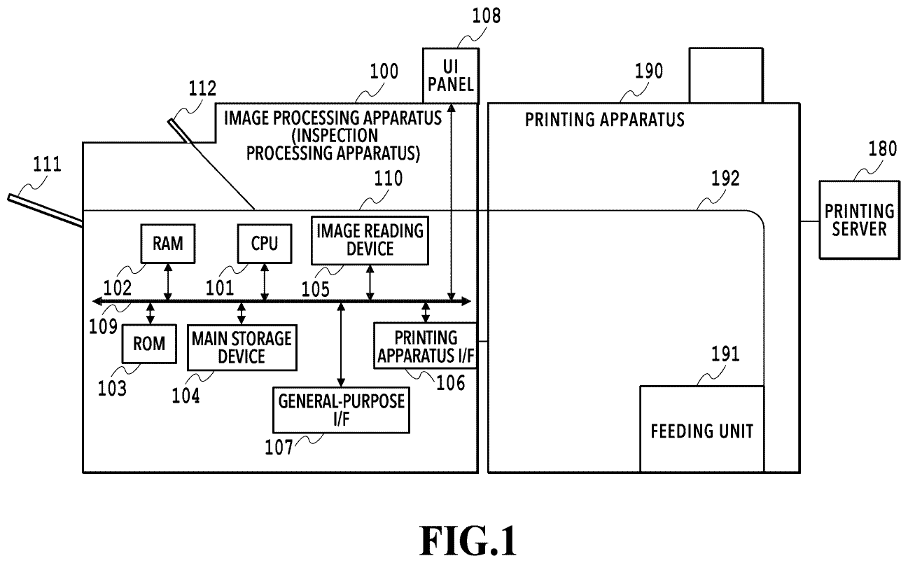

FIG. 1 illustrates a configuration diagram of an entire printing system. The printing system includes an image processing apparatus 100, a printing server 180, and a printing apparatus 190. The printing system outputs the print product and inspects whether there is the printing defect on the outputted print product. Note that, all the image processing apparatus 100, printing server 180, and printing apparatus 190 have an information processing function to process various pieces of information. From an aspect of the information processing function, in a case where the image processing apparatus 100, the printing server 180, and the printing apparatus 190 are not particularly distinguished from each other, each of the image processing apparatus 100, the printing server 180, and the printing apparatus 190 is also referred to as an information processing apparatus. Additionally, the information processing function that can be executed by the information processing apparatus may be implemented on a terminal such as a smartphone and a tablet, for example. In this case, the terminal such as the smartphone and the tablet may have the above-described information processing function. In the example in FIG. 1, the image processing apparatus 100 is arranged on a subsequent stage side of the printing apparatus 190.

### Printing Server 180; Printing Apparatus 190

The printing server 180 has a function of generating a printing job of a document to be printed and inputting the printing job to the printing apparatus 190. The printing apparatus 190 has a function of forming an image on a printing medium based on the printing job inputted from the printing server 180. Hereinafter, the printing medium is also referred to as a printing sheet as needed. Note that, the printing server 180 may be formed as a cloud service. Additionally, the printing apparatus 190 can use a method such as an offset printing method and an electrophotographic method. In the present embodiment, although it is estimated that the printing apparatus 190 performs printing on the printing sheet by the electrophotographic method, illustration of processing units of charging, exposing, developing, transferring, and fixing is omitted. The printing apparatus 190 includes a feeding unit 191 and a conveyance path 192. In the feeding unit 191, the printing sheet is set in advance by a user. In the printing apparatus 190, the printing sheet is fed from the feeding unit 191 to the not-illustrated processing units via the conveyance path 192. Alternatively, in the printing apparatus 190, the printing sheet may be fed from a not-illustrated auto document feeder (ADF). Alternatively, a feeding deck may be arranged on a preceding stage portion of the printing apparatus 190, and the printing sheet may be supplied from the feeding deck. Once the printing job is inputted from the printing server 180, the printing apparatus 190 forms the image on a front side or two sides of the printing sheet set in the feeding unit 191 while conveying the printing sheet along the conveyance path 192 and transmits the printing sheet to the image processing apparatus 100.

### Image Processing Apparatus 100

The image processing apparatus 100 performs inspection processing to inspect whether there is the defect on the print product. As illustrated in FIG. 1, for example, the printing apparatus 190 is arranged on a preceding stage side of the image processing apparatus 100. Therefore, the image is formed by the printing apparatus 190 on the print product, and the print product is supplied to the image processing apparatus 100 via the conveyance path 192. Alternatively, the print product may be put on the not-illustrated ADF and supplied from the ADF to the image processing apparatus 100. Alternatively, the print product may be supplied from a not-illustrated inserter to the image processing apparatus 100. In other words, the image processing apparatus 100 functions as an inspection processing apparatus. Note that, the print product is the printing sheet on which the image is formed. The image processing apparatus 100 includes a CPU 101, a RAM 102, a ROM 103, and a main storage device 104 as units provided inside the image processing apparatus 100. Additionally, the image processing apparatus 100 includes an image reading device 105, a printing apparatus interface (I/F) 106, a general-purpose I/F 107, and a user interface (UI) panel 108 as units provided inside the image processing apparatus 100. In addition, the image processing apparatus 100 includes a main bus 109, a conveyance path 110, a first output tray 111, and a second output tray 112. The conveyance path 110 is connected with the conveyance path 192 and conveys the printing sheet. For example, the print product that passes the inspection is supplied to the first output tray 111. On the other hand, for example, the print product that fails the inspection because the defect is found is supplied to the second output tray 112. Note that, classification of the inspection result of the print product may not be only the two types, which are pass and fail, and may be classified more in detail. Additionally, although an example in which a single image reading device 105 is provided inside the image processing apparatus 100 is illustrated in FIG. 1, it is not particularly limited thereto. For example, the image reading device 105 may be arranged in each of a position facing the front side of the print product and a position facing a back side of the print product along the conveyance path 110. Moreover, an inversion path to invert the front and back of the print product may be provided to the conveyance path 110. The image reading device 105 may read the image formed on the back side of the print product that is inverted front and back by the inversion path.

The CPU 101 is a processor that controls overall the units in the image processing apparatus 100. The RAM 102 functions as a main memory, a working area, and the like of the CPU 101. The ROM 103 stores a program group executed by the CPU 101. The main storage device 104 stores an application executed by the CPU 101, data used for image processing, and the like. The image reading device 105 is formed of a line sensor, for example. The image reading device 105 can read the image formed on one side or two sides of the print product transmitted from the printing apparatus on the conveyance path 110 and can obtain the image as image data. Hereinafter, the image reading device 105 is also referred to as a scanner 105 as needed. The printing apparatus I/F 106 is connected with the printing apparatus 190 and can synchronize a processing timing of the print product with the printing apparatus 190 and can notify of their operation situations to each other. The general-purpose I/F 107 is a serial bus interface such as a USB, IEEE 1394, and the like and allows the user to take out data such as log and take any type of data into the image processing apparatus 100. The UI panel 108 includes, for example, a liquid crystal display and a touch panel laminated on the liquid crystal display and is formed as a liquid crystal display with the touch panel. The UI panel 108 functions as a user interface of the image processing apparatus 100 and displays current situation and setting to notify the user. Additionally, the UI panel 108 accepts an instruction from the user via the touch panel. Note that, the UI panel 108 may not include the touch panel. In this case, a button to accept an operation by the user may be provided to the UI panel 108, for example. The main bus 109 is connected with each unit of the image processing apparatus 100. That is, each unit of the image processing apparatus 100 can transmit and receive various types of data via the main bus 109. For example, the data of the inspection image read by the image reading device 105 can be supplied to the CPU 101 via the main bus 109. In addition, although illustration is omitted, each unit of the image processing apparatus 100 and the printing system including the image processing apparatus 100 may be operated by an instruction from the CPU 101. For example, the image processing apparatus 100 may operate the conveyance path 192 and the conveyance path 110 in synchronization or may switch whether to transmit the print product to the first output tray 111 or the second output tray 112 depending on an inspection result. Additionally, the image processing apparatus 100 may include a GPU in addition to the CPU 101. Moreover, the image processing apparatus 100 may cause a not-illustrated external server to execute a part of the processing of the CPU 101.

In short, based on the image data of the print product read by the scanner 105 while conveying the print product supplied from the printing apparatus 190 on the conveyance path 110, the image processing apparatus 100 performs the inspection processing described below. As a result of the inspection processing, if the print product passes the inspection, the print product is conveyed to the first output tray 111, and if not, the print product is conveyed to the second output tray 112. According to the above-described operation, it is possible to collect only the print product with a confirmed quality to the first output tray 111 as a product to be delivered.

### Functional Configuration of Image Processing Apparatus 100

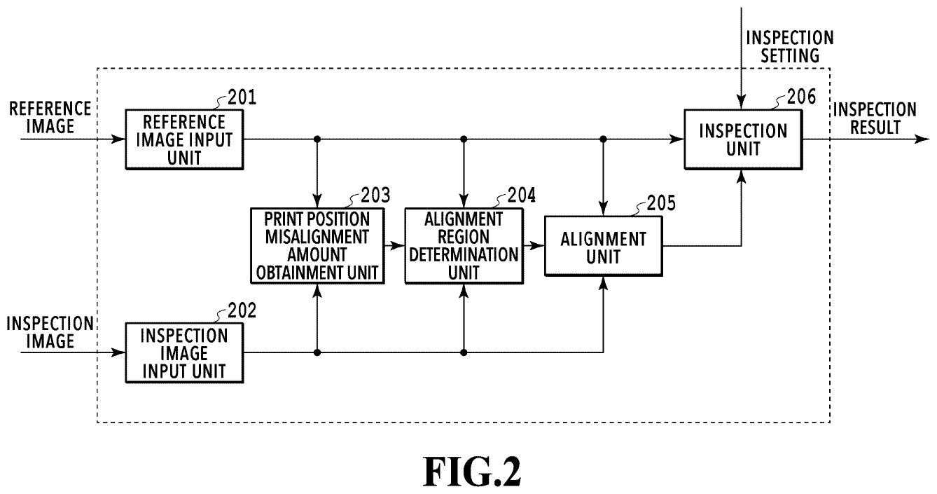

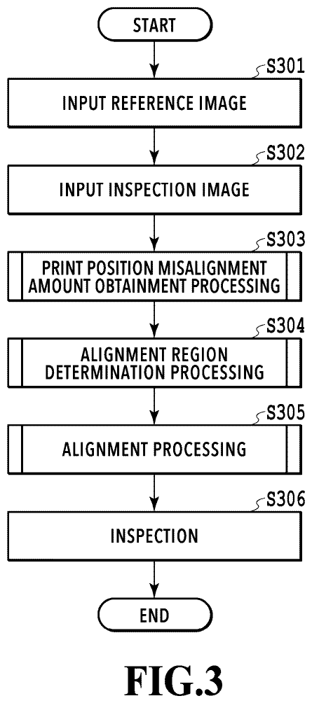

FIG. 2 is a block diagram illustrating a functional configuration of the image processing apparatus 100 in FIG. 1. Note that, the functional configuration illustrated in FIG. 2 is implemented with the functional configuration and a program that implements the functional configuration being supplied to the image processing apparatus 100 illustrated in FIG. 1 and the image processing apparatus 100 executing the program. With the functional configuration illustrated in FIG. 2, the image processing apparatus 100 executes the image processing. An example of the image processing executed by the image processing apparatus 100 is described later with reference to FIG. 3. In the example in FIG. 2, as the functional configuration of the image processing apparatus 100 in FIG. 1, a reference image input unit 201, an inspection image input unit 202, a print position misalignment amount obtainment unit 203, an alignment region determination unit 204, an alignment unit 205, and an inspection unit 206 are implemented. The reference image input unit 201 has a function of taking the reference image including a reference pattern as the reference of the inspection. The reference image including the reference pattern as the reference of the inspection is stored in the RAM 102 or the main storage device 104, for example. The reference image input unit 201 has a function of outputting the above-described reference image to the print position misalignment amount obtainment unit 203, the alignment region determination unit 204, the alignment unit 205, and the inspection unit 206 and inputting to each output destination. The inspection image input unit 202 has a function of taking the inspection image including the pattern as the target of the inspection. The inspection image including the pattern as the target of the inspection is an image obtained by reading the print product by the scanner 105. The inspection image input unit 202 has a function of outputting the inspection image to the print position misalignment amount obtainment unit 203, the alignment region determination unit 204, and the alignment unit 205 and inputting to each output destination. The print position misalignment amount obtainment unit 203 has a function of obtaining the print position misalignment amount by comparing the print positions of the reference image and the inspection image. The print position misalignment amount obtainment unit 203 has a function of outputting the obtained print position misalignment amount to the alignment region determination unit 204. The alignment region determination unit 204 has a function of determining the alignment region to perform alignment of the inspection image to the position of the reference image according to the print position misalignment amount between the reference image and the inspection image. The alignment region determination unit 204 has a function of outputting the determined alignment region to the alignment unit 205. The alignment unit 205 has a function of performing alignment of an image region on the alignment region of the inspection image to the reference image and adjusting a range of the inspection target. The alignment unit 205 has a function of outputting the inspection image, in which the alignment of the alignment region is performed, to the inspection unit 206. The inspection unit 206 has a function of inspecting whether there is the printing defect on the inspection image by comparing the inspection image, in which the alignment of the alignment region is performed, with the reference image. The inspection unit 206 has a function of outputting the inspection result to the printing apparatus 190 or the UI panel 108.

### Image Processing of Image Processing Apparatus 100

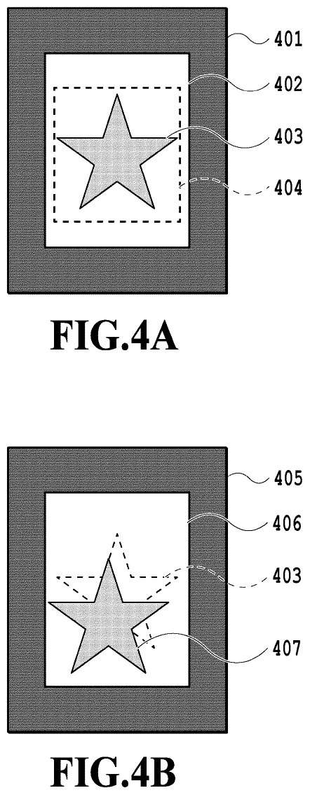

The image processing executed by the image processing apparatus 100 is described with reference to FIGS. 3 and 4. FIG. 3 is a flowchart describing the image processing executed by the image processing apparatus 100 in FIG. 1. FIG. 4 is a diagram illustrating an example of a reference image 401 and an inspection image 405 used in the image processing in FIG. 3. FIG. 4A is a diagram illustrating the reference image 401. FIG. 4B is a diagram illustrating the inspection image 405. A program that executes a content of the present flowchart illustrated in FIG. 3 is stored in the ROM 103, and the program is executed in a case where the user provides an instruction to start the inspection of the inspection image via the UI panel 108, for example.

That is, the processing illustrated in FIG. 3 is implemented with the CPU 101 reading out the program stored in the ROM 103 to the RAM 102 to execute. Specifically, the processing illustrated in FIG. 3 is executed in a timing of starting the inspection of the inspection image. Note that, a part of or all the functions of steps in FIG. 3 may be implemented by hardware such as an ASIC or an electronic circuit. A sign “S” in description of each processing means a step in the flowchart.

In S301, the CPU 101 obtains the reference image 401 for the inspection. Specifically, the reference image input unit 201 obtains the reference image 401 for the inspection from the RAM 102 or the main storage device 104. The reference image input unit 201 inputs the obtained reference image 401 for the inspection to the print position misalignment amount obtainment unit 203, the alignment unit 205, and the inspection unit 206. In the present embodiment, as illustrated in FIG. 4A, a pattern 403 is printed on a printing sheet 402 of the reference image 401. In this case, the pattern 403 included in the reference image 401 corresponds to the reference pattern as the reference of the inspection. In FIG. 4A, a region that is outside the printing sheet 402 and colored with a single color represents a state in which no reflected light is obtained from the printing sheet 402 under the assumption that the region outside the printing sheet 402 is also read by the scanner 105. Note that, in the present embodiment, an alignment region 404 is set. A size and a position of the alignment region 404 are set to include the entire pattern 403. Additionally, the reference image 401 is expressed by image data of 8-bit grayscale, for example. Comparing with a color image, a grayscale image is an image expressing shading in black and white, which expresses each pixel in 8-bit and includes no color information but only brightness information. The image data of 8-bit grayscale can express the shading to 2 to the power of 8=256 levels. Therefore, a pixel value 0 indicates a black pixel, and a pixel value 255 indicates a white pixel.

In S302, the CPU 101 obtains the inspection image 405. Specifically, the inspection image input unit 202 obtains the inspection image 405 obtained with the scanner 105 reading the print product as the inspection target. The inspection image input unit 202 inputs the obtained inspection image 405 to the print position misalignment amount obtainment unit 203, the alignment region determination unit 204, and the alignment unit 205. As illustrated in FIG. 4B, a pattern 407 is printed on a printing sheet 406 of the inspection image 405. In FIG. 4B, a region that is outside the printing sheet 406 and colored with a single color indicates that no reflected light from the printing sheet 406 is obtained because the region outside the printing sheet 406 is also read by the scanner 105. Note that, in the present embodiment, as illustrated in FIG. 4B, the pattern 407 is printed on the printing sheet 406 of the inspection image 405. Because of the conveyance position misalignment of the printing sheet 406 during printing, the pattern 407 is printed in a position misaligned in a lower left direction from the pattern 403 of the reference image 401.

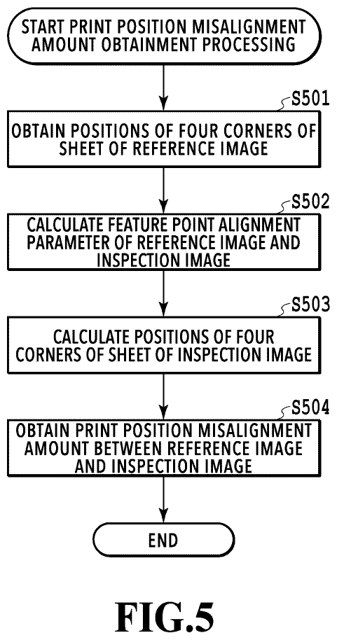

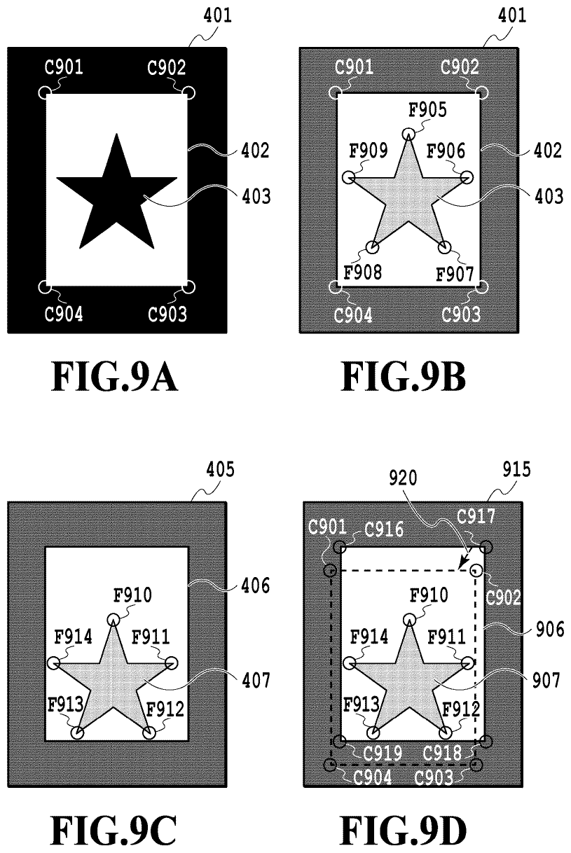

In S303, the CPU 101 executes print position misalignment amount obtainment processing. Specifically, the print position misalignment amount obtainment unit 203 compares the print position of the printing sheet 402 of the reference image 401 and the print position of the printing sheet 406 of the inspection image 405. An example in which four corners of the printing sheet 402 are used as the print position of the printing sheet 402 of the reference image 401 and four corners of the printing sheet 406 are used as the print position of the inspection image 405 is described later. With the processing in S303, the print position misalignment amount obtainment unit 203 obtains the print position misalignment amount between the reference image 401 and the inspection image 405. Details of the print position misalignment amount obtainment processing are described later with reference to FIGS. 5 and 9.

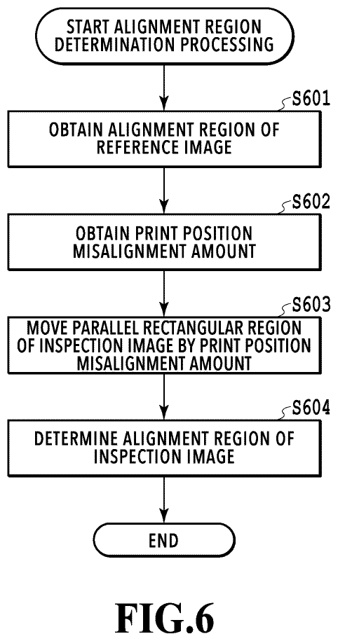

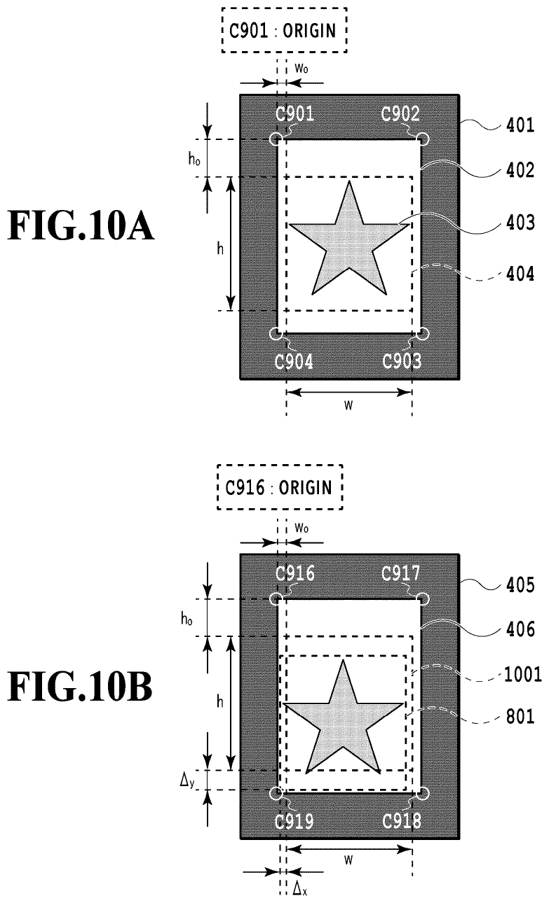

In S304, the CPU 101 executes alignment region determination processing. Specifically, the alignment region determination unit 204 determines the alignment region, in which the alignment between the reference image 401 and the inspection image 405 is performed, based on the print position misalignment amount between the reference image 401 and the inspection image 405. Details of the alignment region determination processing are described later with reference to FIGS. 6 and 10.

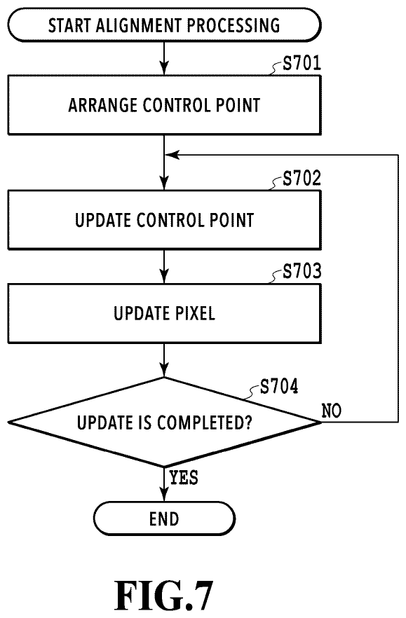

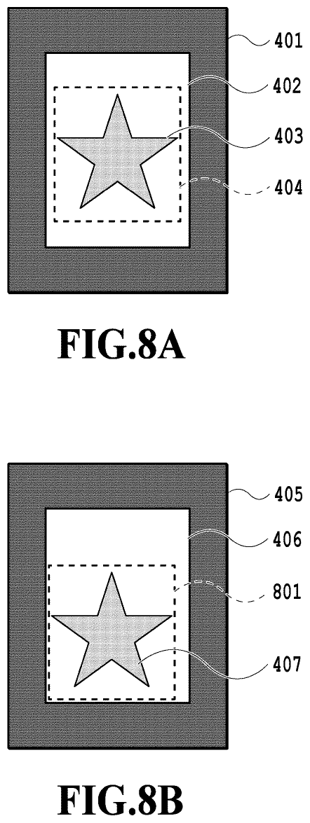

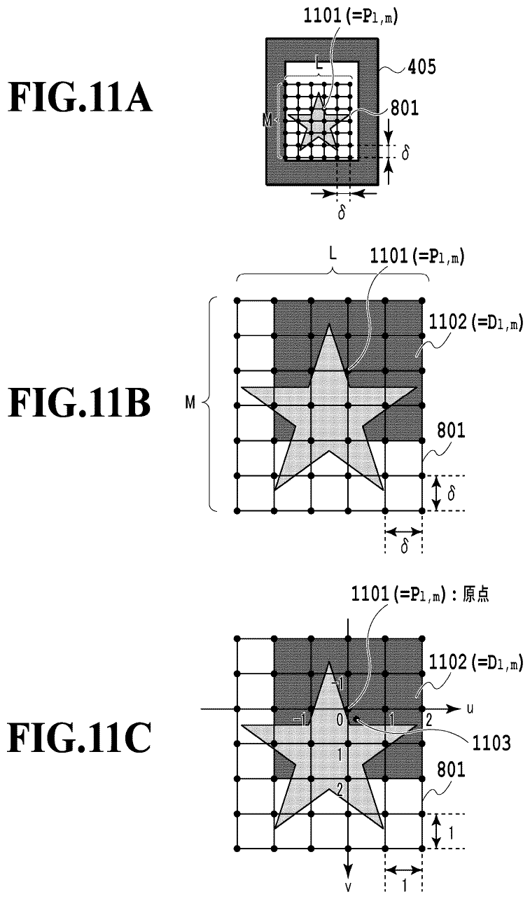

In S305, the CPU 101 executes the alignment processing. Specifically, the alignment unit 205 performs the alignment between the alignment region of the inspection image 405 and the alignment region of the reference image 401. Details of the alignment processing are described later with reference to FIGS. 7 and 11. In S306, the CPU 101 inspects whether there is the printing defect on the inspection image. Specifically, the inspection unit 206 inspects whether there is the defect on the inspection image by comparing the inspection image and the reference image on which the alignment processing is already performed. FIG. 8 is a diagram illustrating an example of the alignment region of each of the reference image and the inspection image used in the processing in S306 in FIG. 3. FIG. 8A is a diagram illustrating the alignment region 404 including the pattern 403 of the reference image 401. FIG. 8B is a diagram illustrating a alignment region 801 including the pattern 407 of the inspection image 405. The alignment is performed on the alignment region 801 in FIG. 8B by geometric transformation from the alignment region 404 in FIG. 8A according to the print position misalignment amount between the reference image 401 and the inspection image 405. According to the inspection setting set in advance by the user, the alignment region 404 of the reference image and the alignment region 801 of the inspection image on which the alignment is performed are compared and inspected. In the present embodiment, since no printing defect is detected on the alignment region 801 of the inspection image 405, the CPU 101 outputs the inspection result indicating pass to the RAM 102 or the main storage device 104 and the printing apparatus 190 and ends the processing. (Image Processing of Print Position Misalignment Amount Obtainment Unit 203)

Details of the print position misalignment amount obtainment processing in S303 in FIG. 3 are described below with reference to FIGS. 5 and 9. FIG. 5 is a flowchart describing the print position misalignment amount obtainment processing in S303 in FIG. 3. FIG. 9 is a diagram illustrating an example of the positions of four corners of the sheet of each of the reference image 401 and inspection images 405 and 915. In this case, the positions of the four corners of the sheet of the reference image 401 mean positions of the four corners of the printing sheet 402. Additionally, the positions of the four corners of the sheet of the inspection image 405 mean positions of the four corners of the printing sheet 406. Moreover, the positions of the four corners of the sheet of the inspection image 915 mean positions of four corners of a printing sheet 906. FIG. 9A is a diagram illustrating an example of the positions of the four corners of the sheet of the reference image 401. FIG. 9B is a diagram illustrating an example of a feature point of the pattern 403 of the reference image 401. FIG. 9C is a diagram illustrating an example of a feature point of the pattern 407 of the inspection image 405. FIG. 9D is a diagram illustrating an example of the inspection image 915 generated by performing the alignment of a pixel position of the feature point of the pattern 407 of the inspection image 405 to a pixel position of the feature point of the pattern 403 of the reference image 401. A program that executes a content of the present flowchart illustrated in FIG. 5 is stored in the ROM 103.

That is, the processing illustrated in FIG. 5 is implemented with the CPU 101 reading out the program stored in the ROM 103 to the RAM 102 to execute. Specifically, the processing illustrated in FIG. 5 is executed in a timing of calling the processing in S303. Note that, a part of or all the functions of steps in FIG. 5 may be implemented by hardware such as an ASIC or an electronic circuit. A sign “S” in description of each processing means a step in the flowchart.

In S501, the CPU 101 obtains the positions of the four corners of the sheet of the reference image 401. Specifically, the print position misalignment amount obtainment unit 203 binarizes the reference image 401, which is the grayscale image, by a publicly-known mode method, Otsu's method, or the like. The mode method is processing of converting the image data into two values, the black pixel and the white pixel, by using a value of a valley as a threshold in a case where the image data is bimodal. Otsu's binarization method is processing of converting the image data into two values, the black pixel and the white pixel, by using a value with the highest class separation degree as a threshold under the assumption that the inside of the image formed of the image data can be divided into two classes, a bright image portion and a dark image portion. The separation degree is expressed by inter-class variance/intra-class variance =inter-class variance/(total variance-inter-class variance). Therefore, in the Otsu's binarization method, the inter-class variance may be maximized. Additionally, in either case of selecting the mode method or the Otsu's method, the image data is converted into either of the pixel value 0 indicating the black pixel and the pixel value 255 indicating the white pixel. Moreover, each pixel value is stored with the pixel position as a set. Since a sheet end of each of the printing sheet 402, the printing sheet 406, and the printing sheet 906 is converted into the white pixel, the position of the sheet end is obtained from the pixel position stored with the white pixel as a set. Specifically, the print position misalignment amount obtainment unit 203 obtains pixels each closest to an upper left end, an upper right end, a lower right end, and a lower left end of the printing sheet 402 of the reference image 401, which are out of pixels of the sheet ends that become the white pixel of the pixel value 255, as the positions of the four corners of the sheet of the reference image 401. In the present embodiment, pixel positions (x₉₀₁, y₉₀₁) to (x₉₀₄, y₉₀₄) of points C₉₀₁ to C₉₀₄ in FIG. 9A are obtained as the positions of the four corners of the sheet of the reference image 401.

In S502, the CPU 101 calculates a parameter that matches the pixel position of the feature point of the reference image 401 and the pixel position of the feature point of the inspection image 405. In this case, the feature point of the reference image 401 means the feature point of the pattern 403 on the printing sheet 402 of the reference image 401. Additionally, the feature point of the inspection image 405 means the feature point of the pattern 403 printed on the printing sheet 402 of the inspection image 405. Specifically, the print position misalignment amount obtainment unit 203 detects the feature point of the reference image 401 and the feature point of the inspection image 405 by the publicly-known Sobel filter processing, Harris corner detection processing, and the like. The Sobel filter processing is filter processing in which a difference between adjacent pixels is obtained and weighting and averaging are performed in the same direction as that of the focusing pixel to emphasize an edge that is a boundary between the bright portion and the dark portion in the image. The Harris corner detection processing is processing in which a value obtained by squaring a difference between a pixel value after movement and a pixel value of an original position is multiplied by a value of a window function to obtain the sum of the movement in all directions, and a point that accordingly has a greatly changed pixel value is detected. In either case of selecting the Sobel filter processing or the Harris corner detection processing, the boundary between the bright portion and the dark portion in the image is obtained. In the present embodiment, points F₉₀₅ to F₉₀₉ in FIG. 9B are detected as the feature points of the reference image 401. Additionally, points F₉₁₀ to F₉₁₄ in FIG. 9C are detected as the feature points of the inspection image 405. The print position misalignment amount obtainment unit 203 calculates a geometric transformation parameter to match the detected feature points of the reference image 401 and feature points of the inspection image 405. As the matching, matching of feature amounts extracted by publicly-known Accelerated KAZE (AKAZE) may be performed, or matching by a k-nearest neighbors algorithm may be performed. The AKAZE is an algorithm that is KAZE at high speed, which performs detection of the feature points and description of the feature amounts, and results thereof may be used to perform matching such as round-robin matching. On the other hand, the k-nearest neighbors algorithm is a method of performing matching by finding K feature points that are nearest to one feature point and predicting the class of the feature point by majority vote of the feature points. In a case where it is possible to perform the alignment by the above-described various types of matching, the print position misalignment amount obtainment unit 203 calculates the geometric transformation parameter required for the alignment as the feature point alignment parameter. The geometric transformation parameter may be calculated as a parameter required to perform publicly-known affine transformation, projective transformation matrix, and the like, for example.

In S503, the CPU 101 obtains the positions of the four corners of the sheet of the inspection image 405. Specifically, the print position misalignment amount obtainment unit 203 calculates the positions of the four corners of the sheet of the inspection image 405 in a case where the alignment between the feature points of the inspection image 405 and the feature points of the reference image 401 are performed from the feature point alignment parameter calculated by the processing in S502. In the present embodiment, as illustrated in FIG. 9D, the inspection image 915 in a state in which the alignment of the feature points of the inspection image 405 to the pixel positions of the feature points of the reference image 401 is performed is generated from the feature point alignment parameter calculated by the processing in S502. In this case, the state in which the alignment of the feature points of the inspection image 405 to the pixel positions of the feature points of the reference image 401 is performed means a state of the geometric transformation from the inspection image 405 into the inspection image 915 based on the feature point alignment parameter. Therefore, the inspection image 915 becomes a converted inspection image of the inspection image 405. Additionally, as with the processing in S501, pixel positions (x₉₁₆, y₉₁₆) to (x₉₁₉, y₉₁₉) of points C₉₁₆ to C₉₁₉ in the four corners of the sheet of the inspection image 915 are calculated in the inspection image 915. In the processing in S504, the print position misalignment amount obtainment unit 203 calculates the print position misalignment amount (Δx, Δy), according to Expression (1) below based on the pixel positions of the four corners of the sheet of the reference image 401 and the pixel positions of the four corners of the sheet of the inspection image 915 calculated by each processing in S501 and S503.

$$( Δ x , Δ y ) = ( \overline{{x}_{i} - {x}_{j}} , \overline{{y}_{i} - {y}_{j}} ) ( i = 901 - 9 \; 04 , j = 916 - 919 ) \qquad Expression ( 1 )$$

That is, the CPU 101 performs the following computation based on converted four corners of the sheet included in the inspection image 915, which is a coordinate-converted inspection image obtained by the geometric transformation from the inspection image 405 based on the geometric transformation parameter, and reference four corners of the sheet included in the reference image 401. In other words, the CPU 101 obtains the print position misalignment amount on a two-dimensional coordinate. As described above, the geometric transformation is performed from the inspection image 405 into the inspection image 915 based on the geometric transformation parameter. With this processing, a coordinate position of the pattern 407 of the inspection image 405 is moved parallel to the pattern 907 of the inspection image 915 by a misalignment amount from a coordinate position of the pattern 403, which is the reference pattern of the reference image 401. Therefore, it is possible to obtain the print position misalignment amount by obtaining a difference between the coordinate position of the reference four corners of the sheet included in the reference image 401 and the coordinate position of the four corners of the sheet included in the inspection image 915.

In the present embodiment, since the pattern 407 in FIG. 8 is printed in a position misaligned in a lower left direction from the pattern 403 of the reference image 401 because of the conveyance position misalignment on the printing sheet 406 during printing, the print position misalignment amount in the lower left direction indicated by an arrow 920 in FIG. 9D is calculated.

### Image Processing of Alignment Region Determination Unit 204

Details of the alignment region determination processing in S304 in FIG. 3 are described below with reference to FIGS. 6 and 10. FIG. 6 is a flowchart describing the alignment region determination processing in S304 in FIG. 3. FIG. 10 is a diagram illustrating an example of the alignment region of each of the reference image 401 and the inspection image 405 used in the processing in S304 in FIG. 3. FIG. 10A is a diagram illustrating an example of the alignment region 404 of the reference image 401 used in the processing in S304 in FIG. 3. FIG. 10B is a diagram illustrating an example of the alignment region 801 of the inspection image 405 used in the processing in S304 in FIG. 3. A program that executes a content of the present flowchart illustrated in FIG. 6 is stored in the ROM 103.

That is, the processing illustrated in FIG. 6 is implemented with the CPU 101 reading out the program stored in the ROM 103 to the RAM 102 to execute. Specifically, the processing illustrated in FIG. 6 is executed in a timing of calling the processing in S304. Note that, a part of or all the functions of steps in FIG. 6 may be implemented by hardware such as an ASIC or an electronic circuit. A sign “S” in description of each processing means a step in the flowchart.

In S601, the CPU 101 obtains the alignment region 404 of the reference image 401. Specifically, the reference image input unit 201 obtains the alignment region 404 of the reference image 401 from the RAM 102 or the main storage device 104. The reference image input unit 201 inputs the obtained alignment region 404 to the alignment region determination unit 204. In the present embodiment, as illustrated in FIG. 10A, the alignment region 404 is set within a range of the printing sheet 402 as a region including the entire pattern 403 printed on the printing sheet 402 of the reference image 401. An upper left corner position of the alignment region 404 is a position away in a lower right direction (w₀, h₀) from the upper left point C₉₀₁ as an origin out of the positions of the four corners of the sheet of the reference image 401 obtained by the processing in S501. The shape of the alignment region 404 is a rectangular shape identified by a width w and a height h. The width w includes an entire shape of the pattern 403 in a horizontal direction and is set at the shortest length. The height h includes an entire shape of the pattern 403 in a vertical direction and is set at the shortest length. Additionally, wo is determined by the shortest distance between a segment connecting the point C₉₀₁ and the point C₉₀₄ and a left end of the alignment region 404. Meanwhile, h₀ is determined by the shortest distance between a segment connecting the point C₉₀₁ and the point C₉₀₂ and an upper end of the alignment region 404.

In S602, the CPU 101 obtains the print position misalignment amount. Specifically, the print position misalignment amount obtainment unit 203 inputs the print position misalignment amount (Δx, Δy) to the alignment region determination unit 204. That is, the alignment region determination unit 204 obtains the print position misalignment amount (Δx, Δy) obtained by the processing in S504.

In S603, the CPU 101 moves parallel a rectangular region 1001 of the inspection image 405 to the alignment region 801 by the print position misalignment amount. Specifically, the alignment region determination unit 204 performs the following processing based on the alignment region 404 of the reference image 401 inputted by the processing in S601 and the print position misalignment amount (Δx, Δy) inputted by the processing in S602. In other words, the alignment region determination unit 204 moves parallel the rectangular region 1001 of the inspection image 405 by the print position misalignment amount (Δx, Δy). Specifically, in the present embodiment, as illustrated in FIG. 10B, the CPU 101 calculates the rectangular region 1001 based on the alignment region 404 of the reference image 401. An upper left corner position of the rectangular region 1001 is a position away in the lower right direction (w₀, h₀) from the upper left point C₉₁₆ as an origin out of the positions of the four corners of the sheet of the inspection image 405 obtained by the processing in S503. The shape of the rectangular region 1001 is a shape identified by the width w and the height h as with the alignment region 404 of the reference image 401.

In S604, the CPU 101 determines the alignment region 801 of the inspection image 405. Specifically, the alignment region determination unit 204 determines the rectangular region 1001 moved parallel by the processing in S603 as the alignment region 801 of the inspection image. In the present embodiment, as illustrated in FIGS. 8B and 10B, the CPU 101 determines a position away in the lower right direction (w₀+Δx, h₀+Δy) from the upper left point C₉₁₆ as an origin out of the positions of the four corners of the sheet of the inspection image 405 as an upper left corner of the alignment region 801. As illustrated in FIG. 10B, the shape of the alignment region 801 is a shape identified by the width w and the height h.

That is, the CPU 101 maps the alignment region 404 on the reference image 401 onto the inspection image 405. With this processing, the rectangular region 1001 is obtained on the inspection image 405 as a region having the same coordinate position and size as that of the alignment region 404. In addition, the region that is obtained by moving parallel the rectangular region 1001 by the print position misalignment amount is determined as the alignment region 801 of the inspection image 405. After this processing, once the alignment processing by non-rigid alignment is performed in the alignment region 801 and in the alignment region 404, only the inside of the range of the alignment region 801 is affected by the alignment. Therefore, the effect of the print position misalignment on the sheet end of the inspection image 405 is reduced.

### Image Processing of Alignment Unit 205

Details of the alignment processing in S305 in FIG. 3 are described below with reference to FIGS. 7 and 11. FIG. 7 is a flowchart describing the alignment processing in S305 in FIG. 3. FIG. 11 is a diagram illustrating an example of a control point arranged in a grid pattern on the inspection image 405 in the processing in S701 in FIG. 7. The alignment processing in S305 is free shape alignment (FFD: Free-Form Deformations), which is known as non-rigid alignment. The non-rigid alignment allows for alignment including not only displacement and rotation of the image but also local scaling and misalignment. In the non-rigid alignment, the image is deformed by arranging multiple control points that control the shape of the image in a grid pattern on the image and moving each of the control points. FIG. 11A is a diagram illustrating an example of the multiple control points arranged on the alignment region 801. FIG. 11B is a diagram illustrating an example of an image region D_{l,m} in the vicinity of a control point P_{l,m} out of the multiple control points in FIG. 11A. FIG. 11C is a diagram illustrating an example of a control point coordinate space that is coordinate-converted by using a control point 1101 that is an update target as the origin. A program that executes a content of the present flowchart illustrated in FIG. 7 is stored in the ROM 103.

That is, the processing illustrated in FIG. 7 is implemented with the CPU 101 reading out the program stored in the ROM 103 to the RAM 102 to execute. Specifically, the processing illustrated in FIG. 7 is executed in a timing of calling the processing in S305. Note that, a part of or all the functions of steps in FIG. 7 may be implemented by hardware such as an ASIC or an electronic circuit. A sign “S” in description of each processing means a step in the flowchart.

In S701, the CPU 101 arranges the control points. Specifically, the alignment unit 205 arranges the multiple control points on the alignment region 801 of the inspection image 405. In the present embodiment, as illustrated in FIG. 11A, L×M control points are arranged in a grid pattern on the inspection image 405. In this process, a distance δ between the control points is obtained based on L, M, and the size of the alignment region 801 of the inspection image 405. In the present embodiment, a coordinate of the point 1101 illustrated in FIG. 11A is represented by a coordinate P_{l,m} (l=1, . . . , L,m=1, . . . , M) of the control point. The control point in the coordinate P_{l,m} (l=1, . . . , L,m=1, . . . , M) represents the control point at l column and m row arranged on the alignment region 801 of the inspection image 405.

In S702, the CPU 101 updates the control point. Specifically, the alignment unit 205 updates the position of the control point at l column and m row according to Expression (2) below:

$${P}_{l , m} = {P}_{l , m} + μ \cdot ( \frac{∇ c}{\vert ∇ c \vert} ) \qquad Expression ( 2 )$$

In this case, μ represents a weighting coefficient, which may be changed according to an update speed of the control point, or a fixed value may be set. In the present embodiment, a fixed value of μ=0.1 is applied. As indicated by Expression (3) below and FIG. 11B, ∇c is a derivative value of the sum of squares of a difference in the pixel values between the inspection image and the reference image after alignment in the image region D_{l,m} in the vicinity of the control point P_{l,m}.

$$∇ c = \frac{\partial }{\partial {P}_{l , m}} {\sum }_{∈ {D}_{l , m}} {( {I}^{′} ( x , y ) - {I}_{r e f} ( x , y ) )}^{2} \qquad Expression ( 3 )$$

I′(x, y) is a pixel value of the inspection image after alignment in the pixel position (x, y), and I_{ref}(x, y) is a pixel value of the reference image in the pixel position (x, y). Σ_{∈Dl,m} represents the sum in the image region D_{l,m}. In the present embodiment, the image region D_{l,m} is a rectangular region 1102 having a width of ±2δ in x, y directions centered at the control point P_{l,m} illustrated in FIG. 11B.

In S703, the CPU 101 updates the pixel. Specifically, the alignment unit 205 updates the inspection image according to Expression (4) below.

$${I}^{′} ( x , y ) = I ( w ( x , y ) ) \qquad Expression ( 4 )$$

Additionally, I(x, y) is a pixel value in the pixel position (x, y) of the inspection image before alignment. As indicated by Expression (5) below, w(x, y) is a pixel position after alignment and is represented by using (u, v). Since w(x, y) is represented by using (u, v), w(x, y) corresponds to the pixel position (x, y) before alignment of the inspection image.

$$w ( x , y ) = {\sum }_{i = - 1}^{2} {\sum }_{j = - 1}^{2} B ( u + i ) B ( v + j ) {P}_{l + i , m + j} \qquad Expression ( 5 )$$

Specifically, (u, v) is expressed by Expressions (6) and (7) below. Additionally, as indicated by a point 1103 in FIG. 11C, the pixel position (u, v) is a coordinate position obtained by standardizing the pixel position (x, y) by the distance δ between the control points during the arrangement and converting on the control point coordinate space whose origin is the control point 1101 (=P_{l,m}) as the update target. Therefore, w(x, y) corresponds to the pixel position (x, y) before alignment of the inspection image.

$$u = x / δ - l \qquad Expression ( 6 )$$

$$v = y / δ - m \qquad Expression ( 7 )$$

As indicated by Expression (8) below, B(t) is a three-dimensional B-spline function. Since the B-spline function itself has locality, only a near control point is affected by the update of the control point.

$$B ( t ) = \{ \begin{matrix}\frac{2}{3} - {\vert t \vert}^{2} + \frac{{\vert t \vert}^{3}}{2} & ( 0 \leq \vert t \vert < 1 ) \\ \frac{{( 2 - \vert t \vert )}^{3}}{6} & ( 1 \leq \vert t \vert < 2 ) \\ 0 & ( 2 \leq \vert t \vert )\end{matrix} \qquad Expression ( 8 )$$

In S704, the CPU 101 determines whether the update is completed. If the update is completed, the CPU 101 ends the processing. If the update is not completed, the CPU 101 returns the processing in S704 to the processing in S702. Specifically, the alignment unit 205 determines whether the update of the control point is completed. In the present embodiment, in a case where a difference between the pixel value I′ of the inspection image and the pixel value I_{ref} of the reference image after alignment is equal to or smaller than a predetermined threshold, the alignment unit 205 determines that the update of the control point is completed and ends the processing. In a case where the difference between the pixel value I′ of the inspection image and the pixel value I_{ref} of the reference image is greater than the predetermined threshold, the alignment unit 205 determines that the update of the control point is not completed and returns the processing in S704 to the processing in S702.

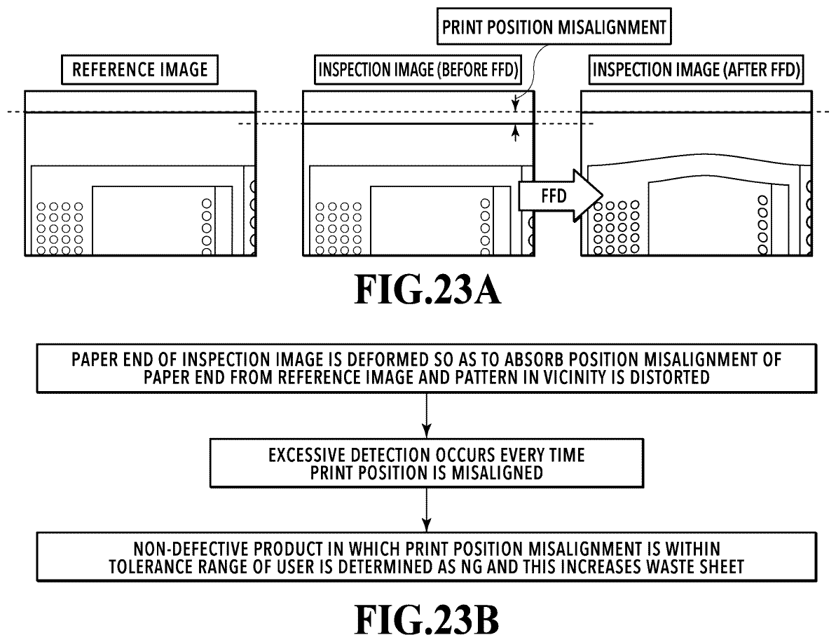

As described above, in PTL 1, the alignment also including the region outside the sheet is performed. For example, an example in which the alignment also including the region outside the sheet is performed by the free shape alignment (FFD: Free-Form Deformations), which is known as the non-rigid alignment, is illustrated in FIG. 23A. In FIG. 23A, as a result of performing the alignment also including the region outside the sheet, the paper end of the inspection image is deformed, and the pattern in the periphery of the paper end is distorted. In a case where the inspection is performed in a state in which the pattern is distorted, the inspection is determined as NG. That is, although it is originally a state in which the pattern is not distorted, the distorted pattern causes excessive detection as the NG determination. The above-described excessive detection occurs every time the print position is misaligned. Therefore, as illustrated in FIG. 23B, the paper end of the inspection image is deformed so as to absorb the misalignment of the paper end from the reference image, and the pattern in the periphery is distorted. This means that the excessive detection occurs every time the print position is misaligned. Therefore, a non-defective product in which the print position misalignment is originally within a tolerance range of the user is determined as NG, and this increases waste sheet. In short, local distortion occurs in the inspection image after alignment, and there may be an effect of the print position misalignment. To deal with this, in the present disclosure, the alignment accuracy during the inspection of the print product is improved. In the present embodiment, the alignment between the alignment region 404 of the reference image 401 illustrated in FIG. 8A and the alignment region 801 of the inspection image 405 illustrated in FIG. 8B is performed. In this case, the position of the alignment region 801 is determined by the geometric transformation according to the print position misalignment amount. Additionally, according to the inspection setting set in advance by the user, the alignment region 404 of the reference image 401 and the alignment region 801 of the inspection image 405 are compared and inspected. In the present embodiment, since no printing defect is detected in the image region on the alignment region 801 of the inspection image 405, the inspection unit 206 outputs the inspection result indicating pass to the RAM 102 or the main storage device 104 and the printing apparatus 190 and ends the processing.

With the above-described image processing being performed, it is possible to perform robust alignment also with the inspection image having a great print position misalignment and to suppress the excessive detection and waste sheet.

Additionally, although the four corners of the white pixel region of the binarized image are obtained as the positions of the four corners in the printing sheet in the present embodiment, the positions of the four corners may be obtained by edge detection processing such as the Sobel filter, and the obtainment method of the position of the sheet end portion is not particularly limited.

Moreover, although a method of moving parallel the alignment region in an example without sheet tilting of the inspection image 405 is described in the present embodiment, even in a case with tilting, the geometric transformation of the alignment region may be performed by publicly-known affine transformation, and it is not particularly limited to the parallel movement of the geometric transformation method.

Furthermore, although a method of the geometric transformation of the rectangular region 1001 of the inspection image 405 into the alignment region 801 is described in the present embodiment, it is not particularly limited thereto. For example, for the inspection image 915 on which the alignment of the feature point is performed with the reference image 401, the same image region as the alignment region 404 of the reference image 401 may be determined as the alignment region of the inspection image 405. Accordingly, the geometric transformation of the inspection image 915 may be performed according to the print position misalignment amount, and the target of the geometric transformation is not particularly limited to the alignment region.

Additionally, although 16 control points, which are P_{l-l,m-1} to P_{l+2,m+2}, are used in the present embodiment to calculate the pixel value I′(x, y) of the inspection image after alignment in the pixel position (x, y), it is not limited thereto. For example, near four control points may be used, and the number of the control points is not particularly limited.

Moreover, although the completion of the update of the control point is determined based on the difference between the pixel values of the reference image 401 and the inspection image 405 after alignment in the present embodiment, it is not particularly limited thereto. For example, as expressed by Expression (3), it may be determined based on whether an absolute value of ∇c is equal to or smaller than a predetermined threshold, and the determination method is not particularly limited to the difference in the pixel values.

### Second Embodiment

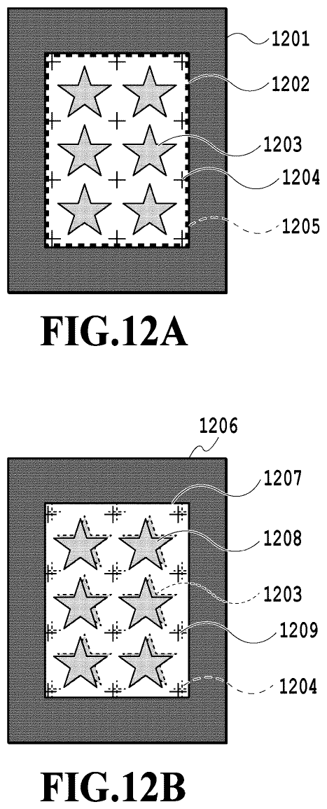

In the first embodiment, the alignment region to perform the alignment between the reference image and the inspection image is determined according to the print position misalignment amount. The image processing that allows for the robust alignment with the above-described processing even in a case where the print position misalignment that is a relative position misalignment between the printing sheet and the pattern on the inspection image is described. However, in a case where a margin of the printing image is narrow, in some cases, a part of the alignment region determined according to the print position misalignment amount protrudes outside the sheet, and thus the alignment accuracy between the reference image not including the region outside the sheet and the inspection image including the region outside the sheet is decreased. To deal with this, in the second embodiment, the region that protrudes outside the sheet from the alignment region on which the geometric transformation is performed according to the print position misalignment amount is excluded. The image processing that allows for the robust alignment with the above-described processing even in a case of the inspection image in which the margin of the printing image is narrow and the print position misalignment is great is described with reference to FIGS. 12 to 15.

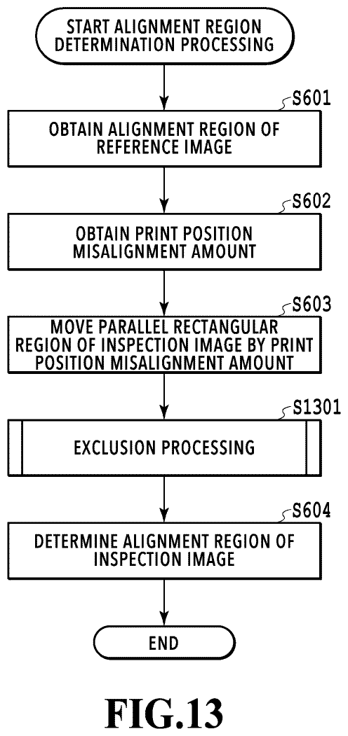

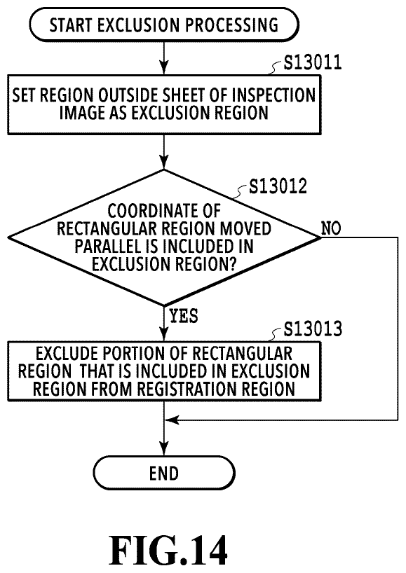

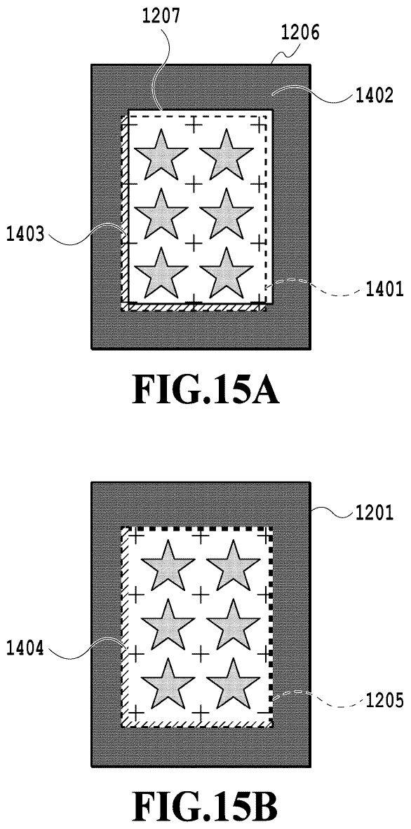

FIG. 12 is a diagram illustrating an example in which a crop mark is additionally set on a reference image 1201 and an inspection image 1206 in the second embodiment. FIG. 12A is a diagram illustrating an example in which a crop mark 1204 is additionally set on the reference image 1201. FIG. 12B is a diagram illustrating an example in which a crop mark 1209 is additionally set on the inspection image 1206. FIG. 13 is a flowchart describing the alignment region determination processing in the second embodiment. FIG. 14 is a flowchart describing processing in S1301 in FIG. 13. FIG. 15 is a diagram illustrating an example of a region excluded in S1301 in FIG. 13. FIG. 15A is a diagram illustrating a region 1403 that is a part of an alignment region 1401 of the inspection image 1206 and that overlaps an excluded region 1402 outside the sheet. FIG. 15B is a diagram illustrating a region 1404 excluded from an alignment region 1205 of the reference image 1201.

In the present embodiment, as illustrated in FIG. 12A, the reference image 1201 is used. A pattern 1203 is printed on a printing sheet 1202 of the reference image 1201. In the present embodiment, the pattern 1203 is formed in a state in which six copies of the pattern 403 are printed on the printing sheet 1202. Additionally, the crop mark 1204 is printed on the printing sheet 1202. The crop mark 1204 indicates a cutting position of each copy. The pattern 1203 and the crop mark 1204 are the inspection target. Additionally, the alignment region 1205 is set on the reference image 1201. The alignment region 1205 is set in a position and a size including all the patterns 1203 and crop marks 1204. Additionally, the reference image 1201 is image data of 8-bit grayscale, for example.

Additionally, in the present embodiment, as illustrated in FIG. 12B, the inspection image 1206 is used. A pattern 1208 is printed on a printing sheet 1207 of the inspection image 1206. In the present embodiment, the pattern 1208 is formed in a state in which the six copies of the pattern 403 are printed on the printing sheet 1207. Additionally, the crop mark 1209 is printed on the printing sheet 1207. The crop mark 1209 indicates the cutting position of each copy. The pattern 1208 and the crop mark 1209 are the inspection target. In the example in FIG. 12B, the pattern 1208 and the crop mark 1209 are printed in a position misaligned in the lower left direction from the pattern 1203 and the crop mark 1204 of the reference image 1201 due to the conveyance position misalignment of the printing sheet 1207 during printing.

### Image Processing of Alignment Region Determination Unit 204

The alignment region determination processing in FIG. 13 is the same processing as the alignment region determination processing in FIG. 6 except the processing in S1301. Therefore, the processing in S1301 is mainly described. In S1301, the CPU 101 executes exclusion processing. The exclusion processing is processing of excluding a region that is a part of the rectangular region 1001 moved parallel by the processing in S603 and that overlaps the excluded region set in advance to be excluded from the alignment region, and details thereof are described later with reference to FIGS. 14 and 15. Next, details of the exclusion processing are described with reference to FIG. 14.

In S13011, the CPU 101 sets the region outside the sheet of the inspection image 1206 as the exclusion region 1402. In this case, the region outside the sheet indicates a region of the inspection image 1206 in FIG. 12B except the printing sheet 1207 and indicates the exclusion region 1402 in FIG. 15A. In S13012, the CPU 101 determines whether a coordinate of the rectangular region 1001 moved parallel by the print position misalignment amount (Δx, Δy) is included in the exclusion region 1402. If the coordinate of the rectangular region 1001 moved parallel by the print position misalignment amount (Δx, Δy) is included in the excluded region 1402, the CPU 101 allows the processing in S13012 to proceed to processing in S13013. In S13013, the CPU 101 excludes a portion of the rectangular region 1001 that is included in the exclusion region 1402 from the alignment region 1401. On the other hand, if the coordinate of the rectangular region 1001 moved parallel by the print position misalignment amount (Δx, Δy) is not included in the exclusion region 1402, the CPU 101 ends the processing in S13012. Note that, in the alignment region 1205 of the reference image 1201, as described later, the region 1404 moved parallel in an opposite direction of the print position misalignment amount (Δx, AΔ) is excluded from the alignment region 1205 of the reference image 1201. In this case, the region 1404 is illustrated as a hatched region.

For example, as illustrated in FIG. 15A, in the alignment region 1401 obtained by moving parallel the rectangular region 1001 by the print position misalignment amount (Δx, Δy), the region 1403 overlapping the exclusion region 1402 outside sheet is excluded from the alignment region 1401 of the inspection image 1206. In this case, the exclusion region 1402 is illustrated as a gray-colored region. The region 1403 is illustrated as a hatched region. Likewise, as illustrated in FIG. 15B, the region 1404 obtained by moving parallel the region 1403 excluded from the inspection image 1206 in the opposite direction of the print position misalignment amount (Δx, Δy) is excluded from the alignment region 1205 of the reference image 1201. In this case, the region 1404 is illustrated as a hatched region.

Accordingly, as illustrated in FIG. 15A, the region that is a part of the alignment region 1401 of the inspection image 1206 and that overlaps the exclusion region 1402 outside the sheet is excluded. Additionally, as illustrated in FIG. 15B, the region that is a part of the alignment region 1205 of the reference image 1201 and that overlaps the exclusion region 1402 outside the sheet is excluded. With the above-described image processing, it is possible to perform the alignment between the region within the sheet in the alignment region 1401 and the region within the sheet in the alignment region 1205. In other words, it is possible to perform the alignment between the alignment regions within the sheet.

As above, the region protruding outside the sheet that is a part of the alignment region 1401 obtained by the geometric transformation of the rectangular region 1001 according to the print position misalignment amount is excluded, and thus it is possible to perform the robust alignment even in a case of the inspection image in which the margin of the printing image is narrow and the print position misalignment is great.

### Third Embodiment

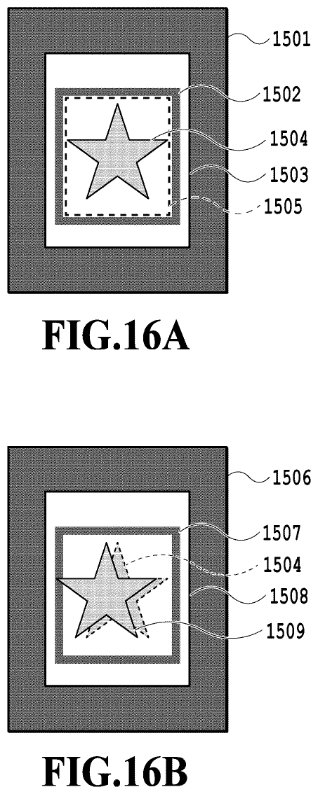

In the second embodiment, the image processing that allows for the robust alignment even in a case of the inspection image in which the margin of the printing image is narrow and the print position misalignment is great by excluding the region protruding outside the sheet that is a part of the alignment region on which the geometric transformation is performed according to the print position misalignment amount is described. However, in a case where additional printing is performed on the print product previously printed, in some cases, the alignment accuracy between the inspection image with a great print position misalignment between previous printing and the additionally printed pattern and the reference image with a small print position misalignment between the previous printing and the additionally printed pattern is decreased. To deal with this, in the present embodiment, a region that is a part of the alignment region on which the geometric transformation is performed according to the print position misalignment amount and that protrudes to the pre-print region is excluded. With this processing, the image processing that allows for the robust alignment for the print position misalignment even in a case where additional printing is performed on the print product previously printed is described with reference to FIGS. 16 to 19.

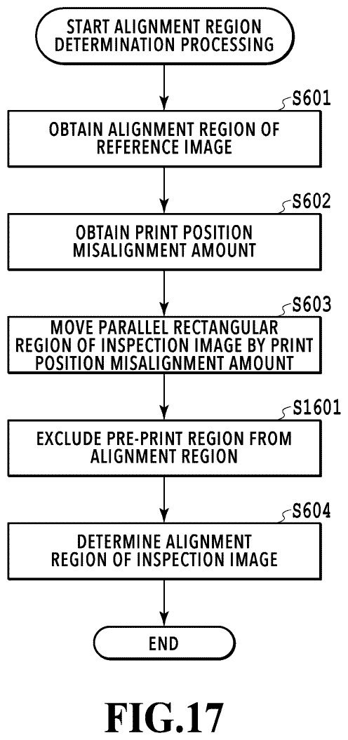

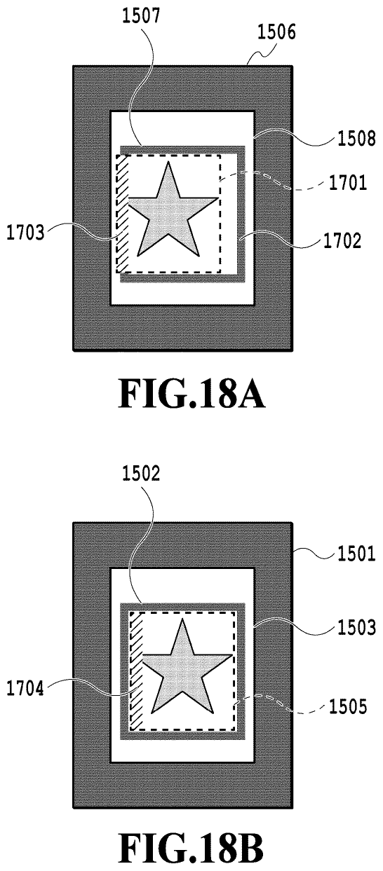

FIG. 16 is a diagram illustrating an example in which additional printing is performed on each of a reference image 1501 and an inspection image 1506 in a third embodiment. FIG. 16A is a diagram illustrating an example in which additional printing is performed on the reference image 1501. FIG. 16B is a diagram illustrating an example in which additional printing is performed on the inspection image 1506. FIG. 17 is a flowchart describing the alignment region determination processing in the third embodiment. FIG. 18 is a diagram illustrating an example of a region excluded in S1601 in FIG. 16. FIG. 18A is a diagram illustrating an example in which a region 1703 that is a part of an alignment region 1701 of the inspection image 1506 and that overlaps a pre-print region 1702 is excluded. FIG. 18B is a diagram illustrating an example in which a region 1704 that is a part of an alignment region 1505 of the reference image 1501 and that is obtained by moving parallel the region 1703 excluded from the inspection image 1506 is excluded.

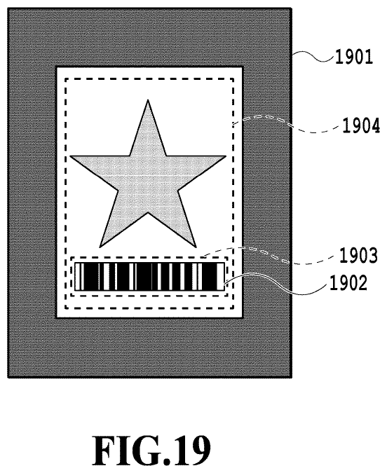

FIG. 19 is a diagram illustrating another example of the excluded region in the third embodiment.

In the present embodiment, as illustrated in FIG. 16A, the reference image 1501 is used. In the reference image 1501, a pattern 1504 is additionally printed on a printing sheet 1503 on which a pattern 1502 is previously printed. The pattern 1504 is the inspection reference. Additionally, the alignment region 1505 is set on the reference image 1501. The alignment region 1505 is set in a position and a size including the entire pattern 1504. Moreover, the reference image 1501 is image data of 8-bit grayscale, for example.

Additionally, in the present embodiment, as illustrated in FIG. 16B, the inspection image 1506 is used. In the inspection image 1506, a pattern 1509 is additionally printed on a printing sheet 1508 on which a pattern 1507 is previously printed. The pattern 1509 is the inspection target. Moreover, in the inspection image 1506, printing is performed in a position misaligned in a left direction from the pattern 1504 additionally printed in the reference image 1501 due to the conveyance position misalignment of the printing sheet 1508 during additional printing.

### Image Processing of Alignment Region Determination Unit 204

The alignment region determination processing in FIG. 17 is the same processing as the alignment region determination processing in FIG. 6 except the processing in S1601. Therefore, the processing in S1601 is mainly described below. In S1601, the CPU 101 excludes the pre-print region from the alignment region. Specifically, the alignment region determination unit 204 excludes the region that is a part of the rectangular region 1001 moved parallel by the processing in S603 and that overlaps the pre-print region of the inspection image 1506 from the alignment region. In the present embodiment, as illustrated in FIG. 18A, the region obtained by moving parallel the rectangular region 1001 of the inspection image 1506 by the print position misalignment amount (Δx, Δy) is set as the alignment region 1701. In the alignment region 1701, the region 1703 (a hatched region) overlapping the pre-print region 1702 (a gray-colored region) on which the pattern 1507 is printed is excluded from the alignment region 1701 of the inspection image 1506. Likewise, as illustrated in FIG. 18B, the region 1704 (a hatched region) obtained by moving parallel the region 1703 excluded from the inspection image 1506 in the opposite direction of the print position misalignment amount (Δx, Δy) is excluded from the alignment region 1505 of the reference image 1501.

As above, even in a case where additional printing is performed on the print product previously printed, it is possible to perform the robust alignment for the print position misalignment by excluding the region that is a part of the alignment region on which the geometric transformation is performed according to the print position misalignment amount and that protrudes to the pre-print region.

In the present embodiment, the region overlapping the pre-print region is excluded from the alignment region; however, during printing on the sheet on which half-cut processing is performed in advance, in some cases, a processing position and the print position may be misaligned. Also in this case, the region overlapping the pre-processing region may be excluded from the alignment region.

Additionally, as illustrated in FIG. 19, in a case where an image 1901 that is previously printed and scanned is used as the reference image, in some cases, during the inspection of a variable print product including a different printing image depending on each inspection image such as a bar code 1902, the user excludes a variable printing region from an inspection region. Also in this case, a region overlapping an inspection excluded region 1903 designated by the user may be excluded from an alignment region 1904.

### Fourth Embodiment

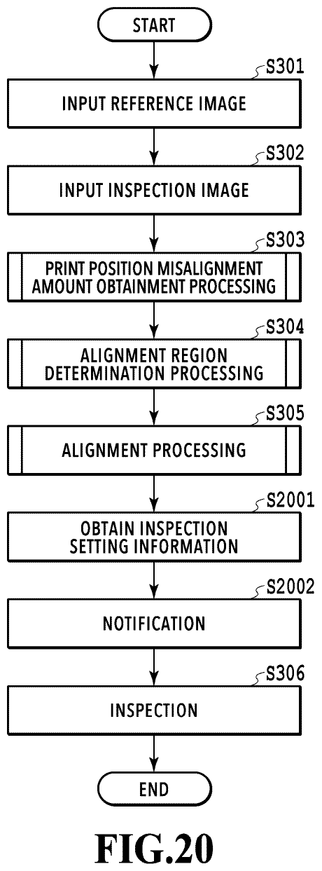

In the first embodiment to the third embodiment, the image processing in which the alignment region is determined according to the print position misalignment amount is described. However, in a case where the determined alignment region does not include the inspection setting region designated by the user, in some cases, the alignment accuracy is decreased in the region, and the inspection processing cannot be executed with the inspection setting designated by the user, or the excessive detection occurs. To deal with this, in a fourth embodiment, processing of warning notification to the user is performed in a case where the alignment region determined according to the print position misalignment amount and the inspection setting designated by the user are not consistent with each other is described with reference to FIGS. 20 to 22.

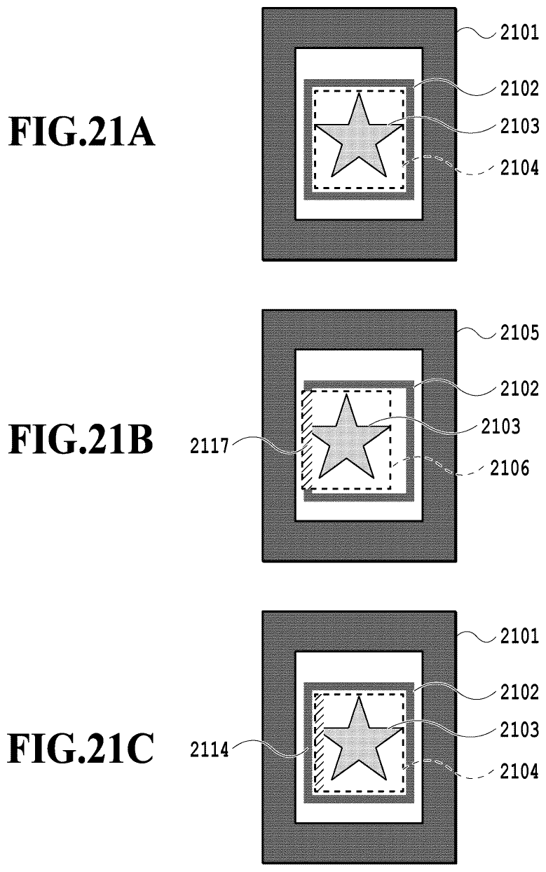

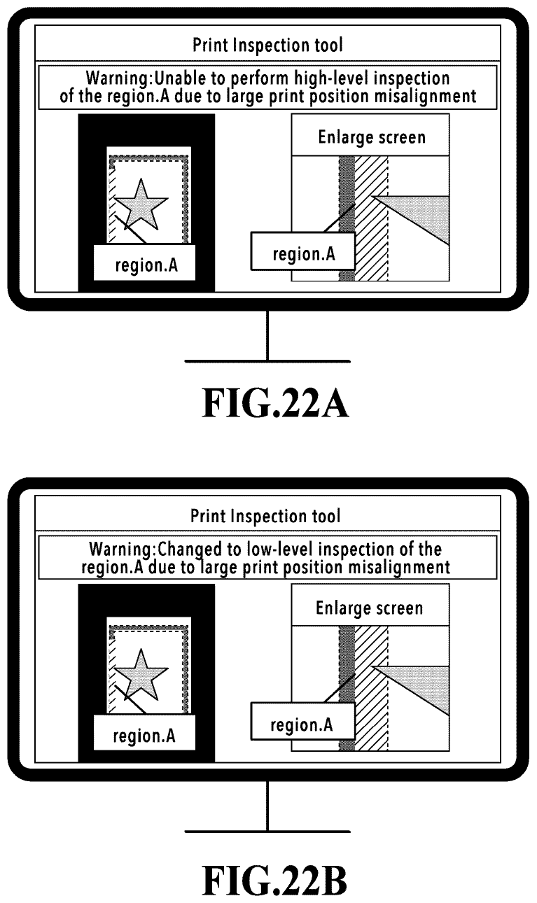

FIG. 20 is a flowchart describing the image processing executed by the image processing apparatus in FIG. 1 in the fourth embodiment. FIG. 21 is a diagram illustrating an example of various regions set on each of the reference image and the inspection image in the fourth embodiment. FIG. 21A is a diagram illustrating an example of a pre-print region 2102 and an emphasized inspection region 2104 set on a reference image 2101. FIG. 21B is a diagram illustrating an example of the pre-print region 2102 and an alignment region 2106 set on an inspection image 2105. FIG. 21C is a diagram illustrating an example in which a part of the emphasized inspection region 2104 included in the reference image 2101 is excluded. FIG. 22 is a diagram illustrating an example of a user warning notification and an inspection setting change notification in the fourth embodiment. FIG. 22A is a diagram illustrating an example of a notification about unavailability of highly accurate inspection. FIG. 22B is a diagram illustrating an example of a notification about changing to simple inspection.

### Processing of Inspection Unit 206

In the image processing in FIG. 20, processing other than each processing in S2001 and S2002 is processed as with the image processing in FIG. 3. The image processing in the present example is described below with reference to FIG. 20.

In S2001, the CPU 101 obtains inspection setting information. Specifically, the inspection unit 206 obtains the inspection setting information. The inspection setting information is information including at least either one of an inspection sensitivity and the inspection region. The inspection setting information is designated by the user, for example. For example, as illustrated in FIG. 21A, the pre-print region 2102 and the emphasized inspection region 2104 are set on the reference image 2101. The simple inspection at a low inspection sensitivity is performed on the pre-print region 2102. The emphasis inspection at a high inspection sensitivity is performed on the emphasized inspection region 2104. The emphasized inspection region 2104 is a region in which a pattern 2103 is additionally printed. In the emphasized inspection region 2104, highly accurate alignment is performed. Therefore, the same region as the emphasized inspection region 2104 is set as the alignment region.

In S2002, the CPU 101 performs notification. Specifically, in a case where the inspection setting information obtained in the processing in S2001 is inconsistent with the alignment region determined in the processing in S304, the inspection unit 206 notifies the user of a warning. For example, in FIG. 21B, an example in which the pattern 2103 is printed in a position misaligned in the left direction due to the conveyance position misalignment during additional printing is illustrated. Additionally, in the example in FIG. 21B, in the inspection image 2105, a part of the alignment region 2106 and a part of the pre-print region 2102 overlap each other. The alignment region 2106 is a region obtained by moving parallel the rectangular region of the inspection image 2105 by the geometric transformation according to the print position misalignment amount. Note that, a region 2117 in which the alignment region 2106 and the pre-print region 2102 overlap each other is illustrated with hatching and excluded from the alignment region 2106. On the other hand, in the example in FIG. 21C, in the reference image 2101, a region 2114 obtained by moving parallel the region 2117 of the inspection image 2105 in the opposite direction of the print position misalignment amount (Ax, Ay) is illustrated with hatching and is excluded from the emphasized inspection region 2104 of the reference image 2101. Therefore, a part of the emphasized inspection region 2104 is excluded from the alignment region 2106. For this reason, it is a state in which highly accurate alignment is not allowed. Accordingly, the alignment region 2106 determined according to the print position misalignment amount is inconsistent with the emphasized inspection region 2104. Therefore, in the present embodiment, as illustrated in FIG. 22A, a determination result of the inconsistency with the inspection setting is outputted to the printing apparatus 190 or the UI panel 108 and notified to the user as a warning.

As above, in a case where the alignment region determined based on the print position misalignment amount is inconsistent with the inspection setting designated by the user, the user is notified of a warning and thus it is possible to avoid the excessive detection along with the decrease in the alignment accuracy in the inconsistent region.

Additionally, although the user is notified of a warning in a case where the inspection setting is inconsistent with the alignment region in the present embodiment, the inspection setting may be changed to that consistent with the alignment region and the user may be notified of details of the change of the inspection setting, and the notification method is not limited to the warning notification. For example, as illustrated in FIG. 22B, in a case where the alignment region determined according to the print position misalignment amount is inconsistent with the emphasized inspection region setting, the inconsistent region excluded from the alignment region may be changed to a simple inspection region that does not need highly accurate alignment. Details of the change of the inspection setting may be outputted to the printing apparatus 190 or the UI panel 108 and notified to the user.

### Other Embodiments

Although descriptions are provided above with various examples and embodiments of the present disclosure, the intent and the scope of the present disclosure are not limited to a specific description of the present specification. The present disclosure is not limited to the above-described embodiments, and various types of deformation may be performed. Additionally, the present disclosure may be an arbitrary combination of a part of the above-described embodiments.

### Modification 1

For example, although an example of the affine transformation to perform parallel movement as the geometric transformation is described, it is not particularly limited thereto. The projective transformation may be applied as the geometric transformation.

### Modification 2

Additionally, for example, although an example in which each processing in S303, S304, and S305 is executed by the image processing apparatus 100 is described, it is not particularly limited thereto. For example, a not-illustrated server that can transmit and receive various signals via the image processing apparatus 100 and the Internet may execute at least one of the processing in S303, S304, and S305. Alternatively, the printing server 180 may execute at least one of the processing in S303, S304, and S305. Alternatively, a not-illustrated cloud service that can provide various services via the image processing apparatus 100 and the Internet may execute at least one of the processing in S303, S304, and S305. Thus, with at least one of the processing in S303, S304, and S305 being executed outside the image processing apparatus 100, it is possible to allocate resources of the CPU 101 to other processing while reducing a load of the CPU 101.

### Modification 3

Moreover, for example, although an example of generating the inspection image 915 in a state in which the feature point of the inspection image 405 is registered with the pixel position of the feature point of the reference image 401 is described, it is not particularly limited thereto. For example, the inspection image in a state in which the feature point of the reference image 401 is registered with the pixel position of the feature point of the inspection image 405 may be generated. In short, any alignment may be performed as long as it is possible to obtain a relative print position misalignment amount between the inspection image 405 and the reference image 401.

### Modification 4

Furthermore, for example, although an example in which the shape of the alignment region 801 is the rectangular shape is described, it is not particularly limited thereto. Since the alignment region 801 is determined based on a hardware performance of the image processing apparatus 100, for example, in a case where a resolution performance to determine the alignment region 801 in the image processing apparatus 100 is 3 mm, it is possible to determine the shape of the alignment region 801 at an interval of 3 mm.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present disclosure, it is possible to improve the alignment accuracy during an inspection of a print product.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

What is claimed is:

1. An image processing apparatus comprising:
an obtainment unit configured to obtain a print position misalignment amount between a reference image, which is a reference of an inspection of a print product, and an inspection image, which is a target of the inspection;
a determination unit configured to determine an alignment region in the inspection image based on the print position misalignment amount, the alignment region being for alignment between the inspection image and the reference image and including a pattern included in the inspection image; and
an alignment unit configured to perform alignment between the inspection image and the reference image based on the alignment region.

2. The image processing apparatus according to claim 1, wherein the obtainment unit obtains a geometric transformation parameter to perform geometric transformation between a feature point of a reference pattern included in the reference image and a feature point of a pattern included in the inspection image.

3. The image processing apparatus according to claim 2, wherein the obtainment unit obtains the print position misalignment amount based on converted four corners of a sheet included in a coordinate-converted inspection image obtained by geometric transformation from the inspection image based on the geometric transformation parameter and reference four corners of a sheet included in the reference image.

4. The image processing apparatus according to claim 3, wherein the obtainment unit starts obtainment of the print position misalignment amount in a case where the reference image and the inspection image are supplied.

5. The image processing apparatus according to claim 3, wherein a rectangular region including the feature point of the pattern is set in the inspection image, and
the determination unit determines the rectangular region moved parallel based on the print position misalignment amount as the alignment region.

6. The image processing apparatus according to claim 2, wherein, as processing of alignment between a position of the reference image and a position of the inspection image, the alignment unit performs alignment between positions of the reference pattern and the pattern included in the inspection image by non-rigid alignment between a reference alignment region including the reference pattern and the determined alignment region.

7. The image processing apparatus according to claim 1, wherein the determination unit determines to exclude a region that overlaps an exclusion region set in advance in the alignment region from the alignment region.

8. The image processing apparatus according to claim 7, wherein the determination unit determines that a region outside a sheet is included in the exclusion region in the inspection image.

9. The image processing apparatus according to claim 7, wherein the determination unit determines that a pre-print region is included in the exclusion region in the inspection image.

10. The image processing apparatus according to claim 7, wherein the determination unit determines that a pre-processing region is included in the exclusion region in the inspection image.

11. The image processing apparatus according to claim 7, wherein the determination unit determines that a user-designated region is included in the exclusion region in the inspection image.

12. The image processing apparatus according to claim 1, further comprising an inspection unit configured to inspect the print product based on the registered inspection image.

13. The image processing apparatus according to claim 1, further comprising a notification unit configured to notify a user of a warning in a case where there is an inconsistent portion between an emphasized inspection region in the inspection image and the alignment region.

14. The image processing apparatus according to claim 1, further comprising a notification unit configured to set an inconsistent portion between an emphasized inspection region in the inspection image and the alignment region as a simple inspection region, in a case where there is the inconsistent portion, and notify a user of setting information of the simple inspection region.

15. An image processing method comprising:
obtaining a print position misalignment amount between a reference image, which is a reference of an inspection of a print product, and an inspection image, which is a target of the inspection;
determining an alignment region in the inspection image based on the print position misalignment amount, the alignment region being for alignment between the inspection image and the reference image and including a pattern included in the inspection image; and
performing alignment between the inspection image and the reference image based on the alignment region.

16. A computer-readable storage medium storing a program causing a computer to execute:
obtaining a print position misalignment amount between a reference image, which is a reference of an inspection of a print product, and an inspection image, which is a target of the inspection;
determining an alignment region in the inspection image based on the print position misalignment amount, the alignment region being for alignment between the inspection image and the reference image and including a pattern included in the inspection image; and
performing alignment between the inspection image and the reference image based on the alignment region.
